(19) United States
(12) Patent Application Publication
(10) Pub. No.: US 2020/0354616 A1
(43) Pub. Date: Nov. 12, 2020

(54) DE-ICING MATERIAL AND METHOD OF FABRICATION THEREOF

(71) Applicant: 9201-6500 QUÉBEC INC., Saint-Jean-sur-Richelieu (CA)

(72) Inventors: Robert BARITEAU, Austin (CA); Julie GENDRON, St-Amable (CA); Michael DESROCHERS, Sorel-Tracy (CA); Weena DURAND, Contrecoeur (CA); Jean-François VERMETTE, Sorel-Tracy (CA); Claude MAHEUX-PICARD, Saint-Marc-sur-Richelieu (CA)

(21) Appl. No.: 16/872,286

(22) Filed: May 11, 2020

Related U.S. Application Data
(60) Provisional application No. 62/845,529, filed on May 9, 2019.

(51) Int. Cl. C09K 3/18

(52) U.S. Cl. CPC C09K 3/185

(57) ABSTRACT

A chloride-free composition and product comprising wood chips and a chloride-free de-icing agent is provided. The wood chips are selected for anti-skid properties and the de-icing agent is selected in the form of an agri-food residue for a deicing action resulting from a lowering of the freezing temperature of an impregnation solution, the woods chips being impregnated with the impregnation solution.

### CROSS REFERENCE TO RELATED APPLICATIONS

This application claims benefit of U.S. application Ser. No. 62/845,529, filed on May 9, 2019. All documents above are incorporated herein in their entirety by reference.

### FIELD OF THE INVENTION

The present invention relates to ice control. More specifically, the present invention relates to a de-icing material and a method of fabrication thereof.

### BACKGROUND OF THE INVENTION

De-icing agents act by lowering the freezing point of water, and thus allowing ice to melt at a temperature below freezing temperature of 0° C. The de-icers need dissolve in the water in order to disrupt the balance between the solid phase, i.e. ice, and the liquid phase, i.e. melted water. Thus, the more de-icer particles are in solution, the lower the freezing temperature will be, and therefore the greater the melting will be for a given temperature. (Lacasse et al., 2014).

For example, sodium chloride NaCl, which is a frequently used de-icing salt, has a number of moles of particles released per mole of dissolved material of 2, since it splits into two ions, Na+ and Cl−, in solution, and magnesium chloride MgCl₂ has a number of moles of particles released per mole of dissolved material of 3, since it splits into Mg2+ and 2 Cl−. Thus, for the same amount of de-icing agent, magnesium chloride MgCl₂ is theoretically be more effective. The nature of the de-icing agent thus has an influence on the melting of the ice, as do several other factors, such as concentration, the physical state of the de-icer (solid or liquid), temperature, etc. (Lacasse et al., 2014).

In contrast abrasives do not affect the freezing point of water, but rather allow for a better adhesion to an ices surface by increasing friction. They are therefore anti-skid agents, as opposed to ice melters, and are used in conjunction with de-icers in certain situations. (Giguére, 2016).

Currently widely used road ice melters are chlorides, specifically sodium chloride (NaCl) and calcium chloride (CaCl₂)). However, they are increasingly considered as having a negative impact on the environment.

The efficiency of de-icing agents may be assessed based on several factors (Muthumani et al. 2014), such as the ability to penetrate and melt ice (frost response strategy); the ability to prevent ice from adhering to the surface (proactive strategy); the time required to dislodge the ice surface; persistence at the application site; and performance relative to other de-icing agents.

To compare the performance of de-icers, the Strategic Highway Research Program (SHRP) has developed a series of tests that can be performed in a laboratory under controlled conditions, which can be found in the Handbook of Test Methods for Evaluating Chemical Deicers (SHRP, 1992). Of these, three separate tests are generally used, namely: an ice melt test (SHRP H-205.1 and H-205.2); an ice penetration test (SHRP H-205.3 and H-205.4); and an ice adhesion test (SHRP 205.5 and H-205.6).

Although SHRP provides good guidance, modifications to the proposed protocols are often required to achieve measurable and reproducible results (WTI, 2010). Some research groups have attempted to develop new approaches, such as the use of a shaker for example. Still, SHRP tests remain the most widely used (Gerbino-Bevins et al., 2012). In addition, real-world tests are still needed in order to take into account external factors that influence ice melting, such as solar radiation, pedestrian traffic, precipitation, temperature variations, humidity, wind conditions, etc. (Gerbino-Bevins et al., 2012).

As previously mentioned, abrasives act as anti-skid agents, i.e. by increasing adhesion. Their efficiency is therefore measured by a friction test, whose metric is the coefficient of static friction, which can be translated into the force required to set in motion any object in contact with a surface, in this case ice. (Hosseini, 2015).

To perform a friction test, several devices are currently available, such as the British Pendulum Tester, a pendulum recommended by the American Society for Testing and Materials (ASTM), or the tribometer, both being relatively expensive. Simpler devices, such as a block that is pulled over a surface, can be used to measure the coefficient of friction of a surface at a lower cost. (Muthumani et al., 2014).

In current days, de-icers/abrasives used for road ice control and other applications generally contain chlorides, which may have environmental impacts, as well as damaging impacts on road infrastructures and vehicles.

There is still a need in the art for a winter use product for ice control and a method of fabrication thereof.

### SUMMARY OF THE INVENTION

More specifically, in accordance with the present invention, there is provided an ice control composition, comprising wood chips and a chloride-free de-icing agent.

There is further provided a method for fabricating an ice control material, comprising selecting wood chips, preparing a chloride-free impregnation solution and impregnating the wood chips with the impregnation solution.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

De-icing and adhesion composition and product comprising agri-food residues was developed through research to determine efficient winter use compositions. In a nutshell, the composition and product comprise wood chips selected and a de-icing agent. The wood chips are selected for anti-skid properties and the de-icing agent is selected in the form of an agri-food residue for a deicing action resulting from a lowering of the freezing temperature of an impregnation solution, the woods chips being impregnated with the impregnation solution.

The product may further comprise a salt of acetic acid such as potassium acetate (AK), or other salts of acetic acid such as calcium/magnesium acetate (CMA) for example, as a de-icing agent.

In an embodiment of an aspect of the present disclosure, the product comprises whey permeate, in amounts comprised between about 6 and about 55% (w/v)), for example in an amount of about 20% (w/v), and potassium acetate (AK) in amounts comprised between about 10 and about 20% (w/v), for example about 20% (w/v).

Wood chips, such as cedar chips, are selected with a smaller grain size than a grain size typically selected for mulch. For example wood chips that pass through a ¾ inch sieve (1.9 cm), as opposed to wood chips remaining on the sieve that are typically used for mulch, are selected. Wood chips in sizes ranging from about 1.0×1.0 to about 1.5×1.5 cm were tested, for example, in order to reach relatively uniform size and distribution allowing for easy spreading and a relatively constant de-icing and sticking action on a spreading surface.

Agri-food residues having a concentration of sugars, proteins, salts, or other compound that allows a freezing temperature lower than the freezing temperature of water when dissolved in a solution may be selected, such as whey permeate, a co-product of the produce of dairy products such as cheese, and urea permeate. Juice from sugar cane extract, corn syrup, glucose syrup, pickle brine, water loaded with starch, cheese brines, by-products of beer making and molasses extract, for example may be used.

A method of fabrication according to an embodiment of an aspect of the present disclosure comprises preparing an impregnation solution and impregnating wood chips with the impregnation solution.

In experiments, an impregnation solution was prepared using whey permeate in a dry form, i.e. in a powder form. Although a liquid form may be contemplated, at concentrations of 6, 20, 40 and 55% (w/v) the liquid form freezes, which may be problematic for storage and spreading. Potassium acetate (AK) was selected in a liquid form in a concentration of 50% (w/v). To achieve target concentrations, typically between about 5 and about 40%, the potassium acetate (AK) was first diluted to, for example, 20% (w/v). Then, the whey permeate powder was added to the diluted potassium acetate solution to obtain the target concentrations, for example, 20% (w/v).

In these experiments, impregnation was carried out by spraying the wood chips as the wood chips were either dry or wet, in such a way that an equal amount of impregnation solution was spread over all the wood chips and all the wood chips were impregnated uniformly, at a rate of 125 ml of impregnation solution for 1 liter of wood chips. On an industrial scale, a method of impregnation may be to pass the wood chips through an auger while simultaneously spraying them with the impregnation solution to achieve the target impregnation rate. Another alternative may be to churn the wood chips while simultaneously spraying them with the impregnation solution.

For all products and temperatures tested, it was found that drying the wood chips after impregnation negatively impacts their resulting de-icing effect without increasing adhesion to the surface.

Tests comprising water addition on wood chips dried after impregnation were conducted to simulate pre-wetting of the wood chips prior to application on surfaces, which is a common practice in many municipalities using abrasives and salt solutions. Such tests also simulate weather precipitation and/or snow melt. It was found that wetting the wood chips that were dried after impregnation allows the de-icing agent impregnated in the wood chips to leach onto the ice, thus optimizing de-icing action, and allows penetration of the impregnated chips into the ice. Wetting was also found to improve wood chips adhesion to spreader iced surfaces. In addition, despite the addition of water, it was found that the impregnated wood chips did not freeze at test temperatures between about −1 and −4° C.

The amount of added liquid de-icing agent is adjusted. A proportion of 50 to 150 ml de-icing agent per liter of wood chips may be selected for example.

In addition, the rate of impregnation and the conditions of storage and/or use of the impregnated wood chips are controlled and the wood chips are kept moist after impregnation. For example, an impregnation rate controlled at 125 ml of de-icing agent per 1 l of wet wood chips, which is about 70% water on a mass basis, was used to obtain wood chips saturated with liquid.

De-icing tests were carried out to assess the efficiency of the obtained product, based on SHRP H-205.1 and H-205.2 de-icing tests. The product was spread on an icy surface and the resulting melt water volume was measured. Different parameters affecting the melting of the ice were modulated in order to obtain an experimental protocol allowing reproducible results. Table I below presents such parameters considered during icebreaking tests.

TABLE I

| | DESCRIPTION | UNIT |
|---|---|---|
| VARIABLES | | |
| Ta | Application rate. Corresponds to the | g/m² or |
| | amount of chips spread on iced surface | ml/m² |
| T | Temperature inside the environmental | ° C. |
| | chamber where the impregnated chips | |
| | are put in contact with the ice for | |
| | a given time | |
| t | Chip action time before friction test | Minutes |
| Ve | Impregnation rate. Corresponds to the | Dimensional |
| | quantity of de-icing agent impregnated | |
| | on chips | |
| S or L | Impregnation time | Minutes |
| H or S | Wet or dry chips | — |
| MEASURED | | |
| Mₛ | Weight of resulting melt water. | g |
| | Corresponds to efficiency of deicer | |

The tests allowed assessing the de-icing effect of the product.

The product was also tested for adhesion to determine its anti-slip action through friction tests. Table II below shows parameters considered in friction tests.

TABLE II

| VARIABLES | DESCRIPTION | UNIT |
|---|---|---|
| ml | Mass pulled on the ice surface | h |
| Ta | Application rate. Corresponds to the | g/m² or |
| | amount of chips spread on the iced | ml/m² |
| | surface | |
| T | Temperature inside the environmental | ° C. |
| | chamber where the deicer is spread | |
| | on ice for a given time | |
| t | Chip action time before the friction | Minutes |
| | test | |
| Ti | Impregnation rate. Corresponds to the | Dimensional |
| | quantity of de-icing agent impregnated | |
| | on the chips | |
| ti | Impregnation time. Time left for the | Minutes |
| | de-icing agent to soak up on wood chips | |
| H or S | Wet or dry chips | — |
| MEASUREDD | DESCRIPTION | |
| m2 | Mass added before block is set in | g |
| | motion | |

Wood chips used as is, i.e. non modified or otherwise processed, are found to have a poor adhesion or de-icing effect on ice. It was found that wood chips mixed with whey permeate powder do not have noticeable adhesion or de-icing effect on ice either. Surprisingly, wood chips impregnated with a whey permeate solution were found to have adhesion properties, although poor de-icing properties.**

It was found that the combination of an acetic acid salt and whey permeate increased the individual deicing action of each one of these components, in a synergistic effect. The whey permeate freezes below about −5° C. The addition of potassium acetate reduces the freezing temperature of the mixture to below −20° C.

The obtained product is under solid form. Since the de-icing agent is impregnated into a solid substrate, i.e. wood chips, leaching of the de-icing agent is limited compared to a liquid de-icer product. In addition, wood chips, used as the solid impregnation substrate, provide adhesion properties to the surface, which allows for less de-icing agent to be used per unit area and thus a reduction in leaching.

It was determined that wood chips dried after impregnation with de-icing agent are less effective than wet wood chips. In addition, adhesion increases with the rate of impregnation, which is the amount of de-icing agent impregnated on the wood chips, and with the rate of wood chips application, which is the amount of wood chips spread over the surface under treatment, in both cases until a plateau is reached.

It was found that impregnation of a de-icing solution with an anti-slip agent makes it easier for the anti-slip agent to become embedded in snow or ice, which increases adhesion, in addition to having a local de-icing effect. The more concentrated the impregnation solution, the stronger the adhesion of the wood chips to snow and ice. Potassium acetate not only improves the de-icing effect of the product, it may further increase the life span of the product by delaying degradation of the product due to the development of wood bacteria and/or sugars in the whey permeate for example.

Thus, the present disclosure teaches recovering organic residues, such as wood chips that otherwise represent a particle size fraction that cannot be used by a mulch or wood chip supplier for example and that may thus typically end up in landfills, and a food co-product, such as whey permeate, whose recovery potential is otherwise limited.

The present product being a chloride-free de-icer/abrasive, use of chlorides, which are responsible for significant environmental impacts, in addition to being corrosive to road infrastructures and vehicles, for winter ice control is avoided.

The present winter use product for snow and ice control, typically on roads, mainly comprises agri-food residues and an acetate, in the absence of chloride; it has de-icing and adhesion properties with lower environmental impacts compared to known products. It is obtained by impregnating wood chips without drying.

The scope of the claims should not be limited by the embodiments set forth in the examples, but should be given the broadest interpretation consistent with the description as a whole.

1. An ice control composition, comprising wood chips and a chloride-free de-icing agent.

2. The ice control composition of claim 1, wherein said de-icing agent comprises potassium acetate.

3. The ice control composition claim 1, comprising at least one of: whey permeate and urea permeate.

4. The ice control composition of claim 1, wherein said de-icing agent comprises acetic acid.

5. The ice control composition of claim 1, wherein said de-icing agent comprises at least one of: potassium acetate and calcium/magnesium acetate.

6. The ice control composition of claim 1, wherein said de-icing agent comprises at least one of: whey permeate and potassium acetate.

7. The ice control composition of claim 1, wherein said de-icing agent comprises whey permeate and potassium acetate.

8. The ice control composition of claim 1, comprising whey permeate in an amount comprised between 6 and 55% (w/v).

9. The ice control composition of claim 1, comprising whey permeate in an amount of 20% (w/v).

10. The ice control composition of claim 1, comprising potassium acetate in an amount comprised between 10 and 20% (w/v).

11. The ice control composition of claim 1, comprising potassium acetate in an amount of 20% (w/v).

12. The ice control composition of claim 1, wherein said wood chips have a ¾ inch sieve size.

13. The ice control composition of claim 1, wherein said wood chips have sizes ranging from 1.0×1.0 to 0.5×1.5 cm.

14. The ice control composition of claim 1, comprising at least one of: whey permeate, urea permeate, juice from sugar cane extract, corn syrup, glucose syrup, pickle brine, starch loaded water, cheese brines, by-products of beer making and molasses extract.

15. An ice control material comprising wood chips, potassium acetate and at least one of: whey permeate and urea permeate.

16. Method for fabricating an ice control material, comprising selecting wood chips, preparing a chloride-free impregnation solution and impregnating the wood chips with the impregnation solution.

17. The method of claim 16, comprising controlling an impregnation rate of the wood chips and maintaining the wood chips moist after impregnation.

18. The method of claim 16, wherein the impregnation solution comprises at least one of: whey permeate, urea permeate, juice from sugar cane extract, corn syrup, glucose syrup, pickle brine, starch loaded water, cheese brines, by-products of beer making and molasses extract; and acetic acid.

19. The method of claim 16, wherein the impregnation solution comprises whey permeate whey permeate and acetic acid.

20. The method of claim 16, comprising using whey permeate in an amount comprised between 6 and 55% (w/v) and potassium acetate in an amount comprised between 10 and 20% (w/v).
